(19) United States
(12) Patent Application Publication
(10) Pub. No.: US 2024/0296494 A1
(43) Pub. Date: Sep. 5, 2024

(54) RETIREMENT ACCOUNT CALCULATOR

(71) Applicant: Richard Lawrence Johnson, Richmond, CA (US)

(72) Inventor: Richard Lawrence Johnson, Richmond, CA (US)

(21) Appl. No.: 18/116,262

(22) Filed: Mar. 1, 2023

(51) Int. Cl. G06Q 40/02

(52) U.S. Cl. CPC G06Q 40/02

(57) ABSTRACT

Methods, systems and computer readable media to provide an improved retirement account calculator with an improved graphical user interface, are described.

### TECHNICAL FIELD

Embodiments relate generally to computerized financial calculation systems, and more particularly, to methods, systems and computer readable media for a retirement account calculator and associated graphical user interface.

### BACKGROUND

Planning for retirement can involve retirement account calculations that help determine a future value of a retirement account. A need may exist for an improved retirement account calculator.

Some implementations were conceived in light of the above-mentioned needs, problems and/or limitations, among other things.

### SUMMARY

Some implementations can include a retirement account calculator having a graphical user interface that permits users to perform an initial retirement account calculation and to subsequently adjust annual contributions and/or interest rates to determine a future value of a retirement account and which can help users better plan contribution amounts, among other things.

In some implementations, the retirement account calculator described herein can be a standalone program that operates within a computing device such as a desktop computer, laptop computer, smartphone, tablet computer or other suitable device. In other implementations, the retirement account calculator can be provided from a server as part of a website or as a web service to users.

### BRIEF DESCRIPTION OF THE DRAWINGS

FIG. 1 shows an example client server environment configured for providing a retirement account calculator with graphical user interface in accordance with some implementations.

FIG. 2 is a diagram of an example retirement account calculator graphical user interface in accordance with some implementations.

FIG. 3 is a diagram of an example retirement account calculator graphical user interface having user interface elements for adjusting each annual contribution amount in accordance with some implementations.

FIG. 4 is a diagram of an example retirement account calculator graphical user interface having user interface elements for adjusting each annual contribution amount and/or each annual interest rate of return in accordance with some implementations.

FIG. 5 is a flowchart showing an example retirement account calculator method in accordance with some implementations.

FIG. 6 is a diagram of an example computing device configured for electronic employment document control in accordance with at least one implementation.

### DETAILED DESCRIPTION

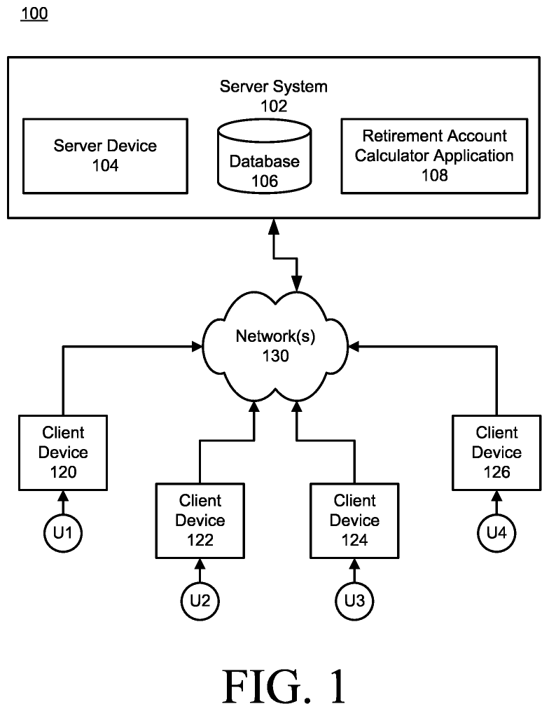

FIG. 1 illustrates a block diagram of an example network environment 100, which may be used in some implementations described herein. In some implementations, network environment 100 includes one or more server systems, e.g., server system 102 in the example of FIG. 1. Server system 102 can communicate with a network 130, for example. Server system 102 can include a server device 104, a database 106 or other data store or data storage device, an a retirement account calculator application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, and 106) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide retirement account calculation functions as described herein.

Various implementations of features described herein can use any type of system and/or service. Any type of electronic device can make use of features described herein. Some implementations can provide one or more features described herein on client or server devices disconnected from or intermittently connected to computer networks.

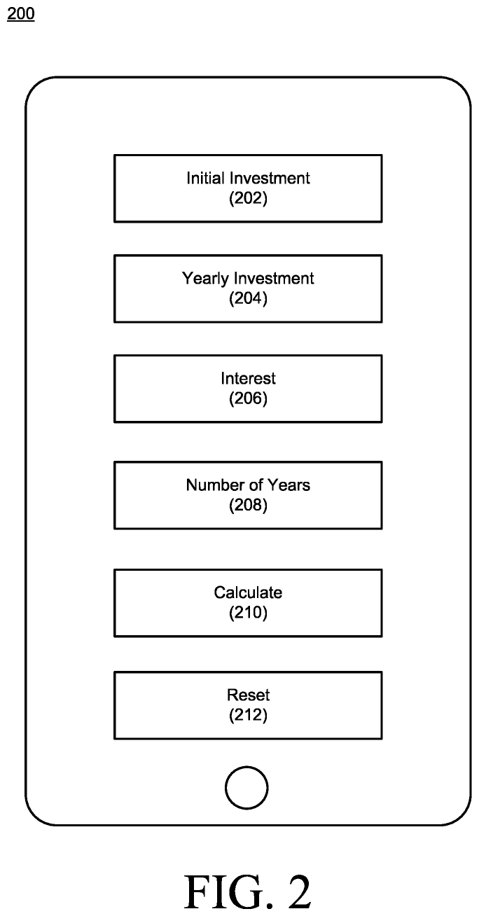

FIG. 2 is a diagram of an example retirement account calculator with improved graphical user interface 200 in accordance with some implementations. The improved graphical user interface includes a graphical user interface element to set or edit an initial investment amount 202, a graphical user interface element to set or edit a yearly (or other time period) investment amount 204, a graphical user interface element to set or edit an interest rate (e.g., corresponding to the yearly or other time period) 206, a graphical user interface element to set or edit a number of years (or other time periods) 208, a calculate element 210, and a reset element 212.

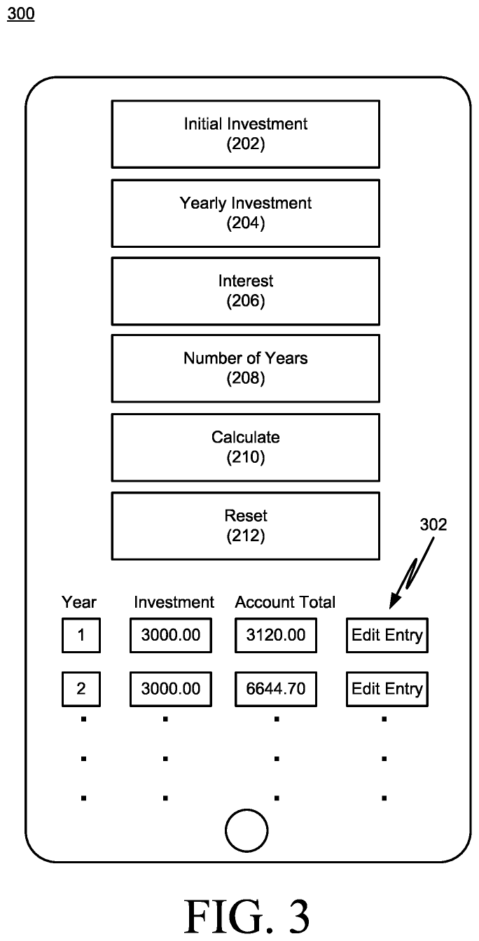

FIG. 3 is a diagram of an example retirement account calculator with improved graphical user interface 300 having user interface elements for adjusting each annual contribution amount in accordance with some implementations. For example, once the calculate element 210 has been selected with the required parameters having been entered (e.g., 202-208), the retirement account calculator with improved graphical user interface updates to show the number of years (or other time periods) along with the account total for each year and concluding with an account total for the entire duration of years. Each row representing a year can include an edit entry graphical user interface element 302 that, when selected, permits a user to edit the annual investment for that year. In some implementations, the edit entry button is selected 302 and once a value has been entered for the annual investment, the same button can be selected again to set the value. The retirement account calculator can then automatically update the account value calculations or can update the account value calculations in response to a user selecting calculate 210.

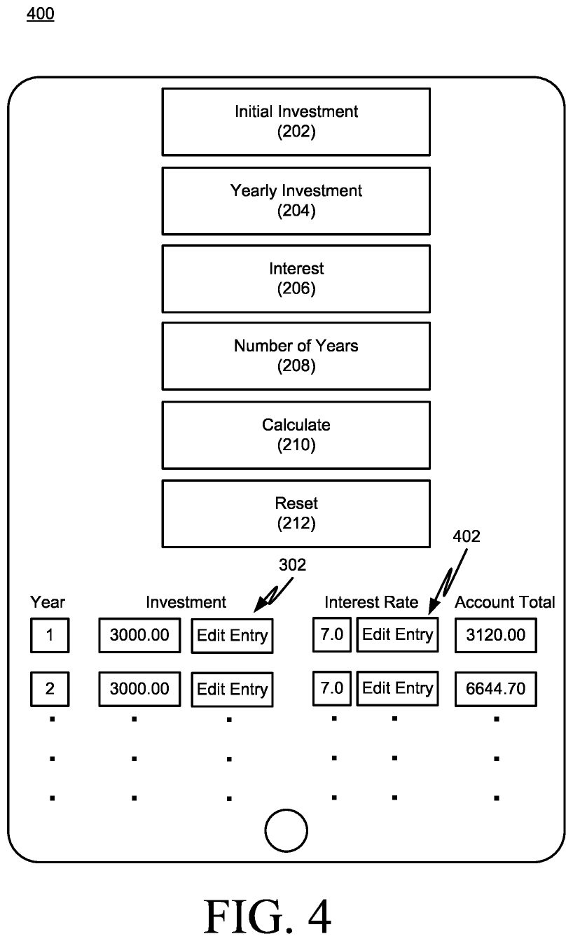

FIG. 4 is a diagram of an example retirement account calculator with improved graphical user interface 400 having user interface elements for adjusting each annual contribution amount and/or each annual interest rate of return in accordance with some implementations. For example, once the calculate element 210 has been selected with the required parameters having been entered (e.g., 202-208), the retirement account calculator with improved graphical user interface updates to show the number of years (or other time periods) along with the account total for each year and concluding with an account total for the entire duration of years. Each row representing a year can include an edit entry graphical user interface element 302 that, when selected, permits a user to edit the annual investment for that year. Each row in 400 can also include an edit entry element 402 for the interest rate. In some implementations, the edit entry button 302 (or 402) is selected and once a value has been entered for the annual investment (or interest rate), the same button can be selected again to set the value. The retirement account calculator can then automatically update the account value calculations or can update the account value calculations in response to a user selecting calculate 210.

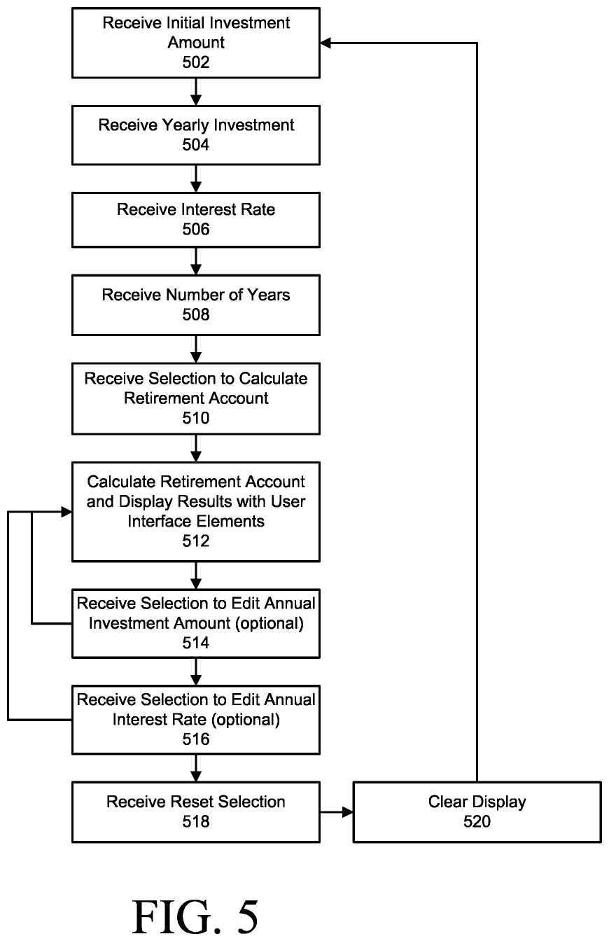

FIG. 5 is a flowchart showing an example retirement account calculator method in accordance with some implementations. Processing begins at 502, where an initial investment amount is received (e.g., via element 202). Processing continues to 504.

At 504, a yearly investment amount is received (e.g., via element 204). It will be appreciated that yearly or annual values are used as a non-limiting example to illustrate the disclosed subject matter and that other time periods may be used. The yearly investment amount entered can be used to calculate the retirement account value for uniform contributions. Processing continues to 506.

At 506, an interest rate is received (e.g., via element 206). The interest rate can correspond to the time period being used for calculation (e.g., annual, monthly, etc.). Processing continues to 508.

At 508, a number of years (or other time periods) is received (e.g., via element 208). Processing continues to 510.

At 510, a selection of the calculate element (e.g., 210) is received. Processing continues to 512.

At 512, in response to the calculate element being selected, the system calculates the annual value of the retirement account and the final total amount, and displays these values in the improved graphical user interface. Processing continues to 514.

At 514, an optional selection to edit an annual investment amount is received (e.g., via 302). Once the edited annual investment value is received, the retirement account can be automatically or manually updated or recalculated. Processing continues to 516.

At 516, an optional selection to edit an interest rate is received (e.g., via 402). Once the edited interest rate value is received, the retirement account can be automatically or manually updated or recalculated. Processing continues to 518.

At 518, a reset element selection is received (e.g., via 212). Processing continues to 520.

At 520, in response to the reset element selection being received, the retirement account calculator display is cleared. Processing continues to 502.

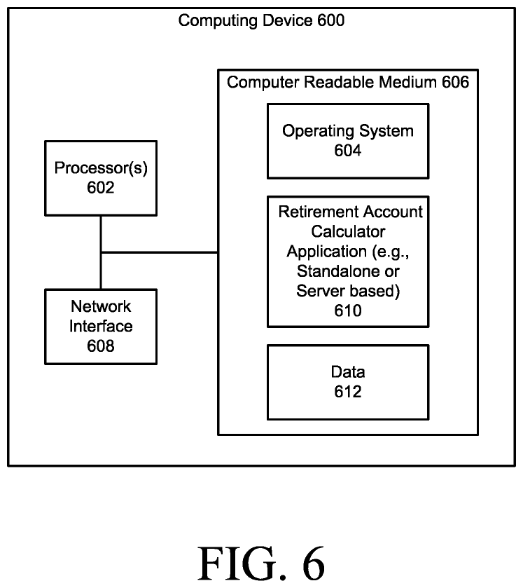

FIG. 6 is a diagram of an example computing device 600 in accordance with at least one implementation. The computing device 600 includes one or more processors 602, nontransitory computer readable medium 606 and network interface 608. The computer readable medium 606 can include an operating system 604, an application 610 for retirement account calculator functions and a data section 612 (e.g., for storing retirement account data such as annual contribution amounts, initial account amount, interest rates, etc.).

In operation, the processor 602 may execute the application 610 stored in the computer readable medium 606. The application 610 can include software instructions that, when executed by the processor, cause the processor to perform operations to perform retirement account calculator with graphical user interface in accordance with the present disclosure (e.g., performing associated functions described above and shown in FIG. 5).

The application program 610 can operate in conjunction with the data section 612 and the operating system 604.

It will be appreciated that the modules, processes, systems, and sections described above can be implemented in hardware, hardware programmed by software, software instructions stored on a nontransitory computer readable medium or a combination of the above. A system as described above, for example, can include a processor configured to execute a sequence of programmed instructions stored on a nontransitory computer readable medium. For example, the processor can include, but not be limited to, a personal computer or workstation or other such computing system that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C, C++, C#.net, assembly or the like. The instructions can also comprise code and data objects provided in accordance with, for example, the Visual Basic™ language, or another structured or object-oriented programming language. The sequence of programmed instructions, or programmable logic device configuration software, and data associated therewith can be stored in a nontransitory computer-readable medium such as a computer memory or storage device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Example structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and/or a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product (or software instructions stored on a nontransitory computer readable medium) may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the software engineering and computer networking arts.

Moreover, embodiments of the disclosed method, system, and computer readable media (or computer program product) can be implemented in software executed on a programmed general-purpose computer, a special purpose computer, a microprocessor, a network server or switch, or the like.

It is, therefore, apparent that there is provided, in accordance with the various embodiments disclosed herein, methods, systems and computer readable media to provide an improved retirement account calculator having an improved graphical user interface.

While the disclosed subject matter has been described in conjunction with a number of embodiments, it is evident that many alternatives, modifications and variations would be, or are, apparent to those of ordinary skill in the applicable arts. Accordingly, Applicants intend to embrace all such alternatives, modifications, equivalents and variations that are within the spirit and scope of the disclosed subject matter.

What is claimed is:

1. A computer-implemented method to display and control a retirement account calculator having an improved graphical user interface, the method comprising:
causing to be displayed an initial investment amount graphical user interface element to set or edit an initial investment amount;
causing to be displayed a recurring investment amount graphical user interface element to set or edit a recurring investment amount;
causing to be displayed an interest rate graphical user interface element to set or edit an interest rate;
causing to be displayed a number of time periods graphical user interface element to set or edit a number of time periods;
causing to be displayed a calculate graphical user interface element;
causing to be displayed a reset graphical user interface element;
receiving, via the initial investment amount graphical user interface element, the initial investment amount;
receiving, via the recurring investment amount graphical user interface element, the recurring investment amount;
receiving, via the interest rate graphical user interface element, the interest rate;
receiving, via the number of time periods graphical user interface element, the number of time periods;
receiving, via the calculate graphical user interface element, an indication to calculate the retirement account values;
based on receiving the indication to calculate retirement account value, calculating a value of a retirement account at each time period for the number of time periods;
causing to be displayed a number of rows equal to the number of time periods, where each row includes an account value for that time period, an investment amount for that time period, an interest rate for that time period, and an edit investment amount graphical user interface element;
receiving an indication of selection of the edit investment amount graphical user interface element;
in response to receiving the indication of selection of the edit investment amount graphical user interface element, permitting the investment amount for the time period corresponding to the edit investment amount graphical user interface element to be edited; and
recalculating the investment account value for each of the time periods based on the edited investment amount;
causing to be displayed a number of rows equal to the number of time periods, wherein the displayed rows include values recalculated based on the edited investment amount.

2. The computer-implemented method of claim 1, further comprising:
causing to be displayed in each row an additional graphical user interface element to edit the interest rate for the time period corresponding to the row;
when the additional graphical user interface element is selected for a given row, permitting the interest rate for that row to be edited; and
recalculating the investment account value for each of the time periods based on the edited interest rate;
causing to be displayed a number of rows equal to the number of time periods, wherein the displayed rows include values recalculated based on the edited interest rate.

3. The computer-implemented method of claim 1, further comprising:
receiving a selection of the reset graphical user interface element; and
in response to receiving the selection of the reset graphical user interface element, removing the rows from the graphical user interface and clearing values in the initial investment amount graphical user interface element, the recurring investment amount graphical user interface, the interest rate graphical user interface element, and the number of time periods graphical user interface element.

4. The computer-implemented method of claim 1, wherein the time period is a year.

5. The computer-implemented method of claim 1, wherein the interest rate is an annual interest rate.
